(19) United States
(12) Patent Application Publication
(10) Pub. No.: US 2007/0138833 A1
(43) Pub. Date: Jun. 21, 2007

(54) Energy absorption device

(75) Inventors: Glenn A. Cowelchuk, Chesterfield Tw., MI (US); David J. Dooley, Troy, MI (US); Todd L. DePue, Brighton, MI (US)

Correspondence Address: MACMILLAN, SOBANSKI & TODD, LLC, ONE MARITIME PLAZA-FIFTH FLOOR, 720 WATER STREET, TOLEDO, OH, 43604, US

(73) Assignee: Lear Corporation

(21) Appl. No.: 11/313,460

(22) Filed: Dec. 20, 2005

(51) Int. Cl. B60R 13/02

(52) U.S. Cl. 296/187.05

(57) ABSTRACT

An energy absorption device for use in a vehicle interior includes a first body having a protrusion defining an axially extending outer serrated surface, and a second body having a cavity defining an axially extending inner serrated surface. The protrusion is at least partially inserted into the cavity to at least partially support the first body relative to the second body. Upon an impact at least partially in the axial direction, one of the protrusion and the cavity is moved relative to the other to absorb at least some of the impact energy. An energy absorption vehicle interior assembly includes an energy absorption device connected between an interior vehicle trim member and a vehicle trim mounting member.

### BACKGROUND OF THE INVENTION

This invention relates in general to an energy absorber for use in a vehicle, and, in particular, to an energy absorbing device for use in a vehicle interior which cushions the occupant during an impact with an interior member of a vehicle.

Vehicle interiors are often provided with energy absorbers designed to absorb energy between an occupant and a structural member when the occupant is thrown against an interior trim member mounted to the structural member. Such energy absorbers are typically positioned between a structural member of the vehicle body and one or more interior trim pieces. Vehicle interiors typically include a variety of decorative and functional trim panels. For example, the front area of the interior of a vehicle, generally referred to as the cockpit area, includes an instrument panel, typically formed of a molded plastic material. The side areas include door panels, typically formed of a molded plastic material, to cover the frame structure and mechanics of the vehicle doors. Often, energy absorbers are placed behind these panels and attached to vehicle structural members to absorb impact energy during a collision. Additionally, an energy absorber may be positioned between the front pillars (i.e., the A-pillar or the B-Pillar) and an interior trim piece covering the pillar. Examples of some types of energy absorbers are described in U.S. Pat. No. 5,098,124.

### BRIEF SUMMARY OF THE INVENTION

This invention relates to an improved energy absorption device for vehicle interiors, which is operable to absorb energy from an impact with an occupant of the vehicle.

In one aspect, the present invention includes an energy absorption device including a first body having a protrusion defining an axially extending outer serrated surface, and a second body having a cavity defining an axially extending inner serrated surface. The protrusion is at least partially inserted into the cavity to at least partially support the first body relative to the second body. Upon an impact at least partially in the axial direction, one of the protrusion and the cavity is moved relative to the other to absorb at least some of the impact energy. Depending upon the configuration of the energy absorption device the impact energy may be absorbed at a variable or non-linear rate.

In another aspect, the present invention includes an energy absorption vehicle interior assembly including an energy absorption device connected between an interior vehicle trim member and a vehicle trim mounting member.

One embodiment of the present invention includes a two-piece nested arrangement with textured engaging walls. In one case, a cavity and a protrusion with a serrated texture is used to control energy management. For example, such and arrangement may be employed within a vehicle door armrest. The serrated texture is used to create a dimensionally stable part in two directions (dimensions) and control energy management in the other (third).

Various objects and advantages of this invention will become apparent to those skilled in the art from the following detailed description, when read in light of the accompanying drawings.

### BRIEF DESCRIPTION OF THE DRAWINGS

FIG. 1 is a perspective view of the interior passenger compartment of a vehicle, and showing various locations where an energy absorption device according to the present invention can be used.

FIG. 2 is an enlarged cross-sectional view of an embodiment of an energy absorption device in accordance with the present invention.

FIG. 3 is an enlarged cross-sectional view of alternative embodiment of an energy absorption device in accordance with the present invention.

FIG. 4 is a schematic view of a profile of an alternative contour of a portion of an energy absorption assembly in accordance with the present invention.

FIG. 5 is a schematic view of a profile of another alternative contour of a portion of an energy absorption assembly in accordance with the present invention.

FIG. 5A is a schematic view of a profile of an additional alternative contour of a portion of an energy absorption assembly in accordance with the present invention.

FIG. 6 is an enlarged cross-sectional view of a portion of a vehicle interior door panel assembly, wherein one embodiment of an energy absorption device according to the present invention is positioned between a main door trim panel and a door armrest.

FIG. 7 is a view of the portion of FIG. 6 after an impact of a vehicle occupant against the armrest.

### DETAILED DESCRIPTION OF THE PREFERRED EMBODIMENT

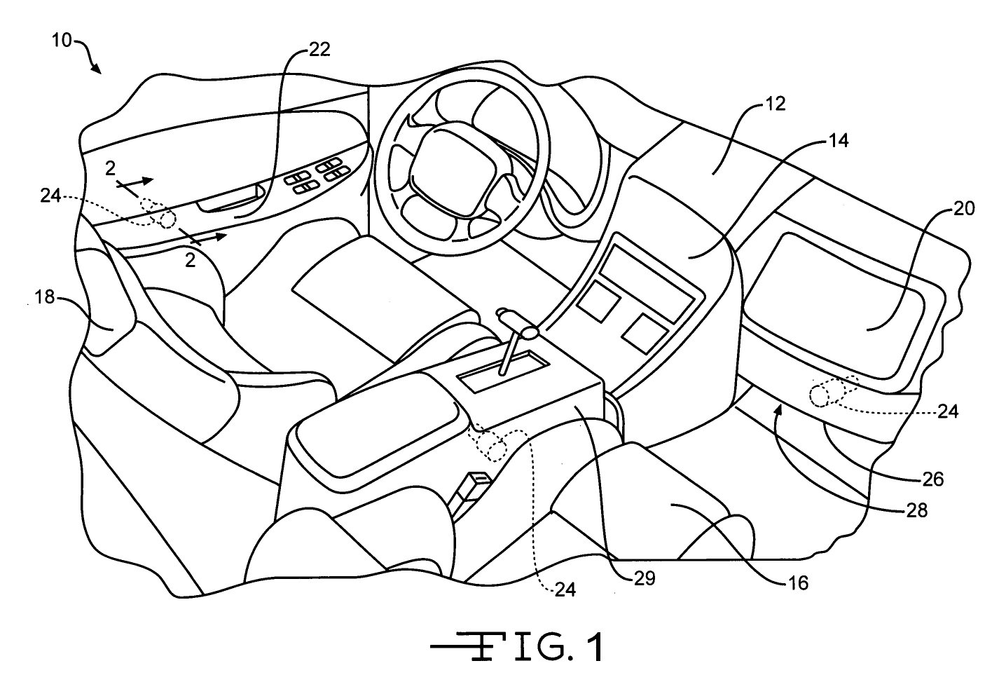

Referring now to the drawings, there is illustrated in FIG. 1 a portion of an interior passenger compartment of a vehicle, indicated generally at 10. The illustrated vehicle interior passenger compartment 10 is, in large measure, conventional in the art and is intended merely to illustrate one environment in which this invention may be used. Thus, the scope of this invention is not intended to be limited for use with the specific structure for the vehicle interior passenger compartment illustrated in FIG. 1. On the contrary, as will become apparent below, this invention may be used in the environment of any suitable vehicle interior passenger compartment for the purposes described below.

The vehicle interior passenger compartment 10 includes an instrument panel or dashboard 12. Various visual gauges for the driver's convenience, and various temperature and climate controls are positioned within the instrument panel 12. Other controls, storage compartments and stereo controls may be positioned within the instrument panel 12 or within a lower console 14. The lower console 14 is positioned between a passenger seat 16 and a driver seat 18. Also located within the passenger compartment is a glove box 20 that may be partially disposed within the instrument panel 12. The vehicle interior passenger compartment 10 may be partially defined by vehicle doors 22, one shown.

An energy absorption device 24 is positioned within the vehicle door 22. However, it will be appreciated that the energy absorption device 24 may be positioned within or associated with any suitable member of the vehicle interior passenger compartment 10. For example, the energy absorption device 24 may be associated with the glove box 20 and provided with a trim cover panel 26 to form an energy absorption assembly in the form of a knee bolster 28 as will be further discussed below. It must be understood, however, that the energy absorption device 24 may be positioned in or around any suitable location in the vehicle interior passenger compartment 10. In another example, the energy abortion device 24 is located with a center console 29 to absorb the impact energy from the lateral movement of an occupant.

The energy absorption device 24 is operable to absorb impact energy during a collision, as will be further described below. Generally, during a collision of the vehicle with another object, occupants of the vehicle tend to impact portions of vehicle interior passenger compartment 10. The energy absorption device 24 tends to absorb at least some of the impact energy and thus reduce the likelihood of injury to the occupants.

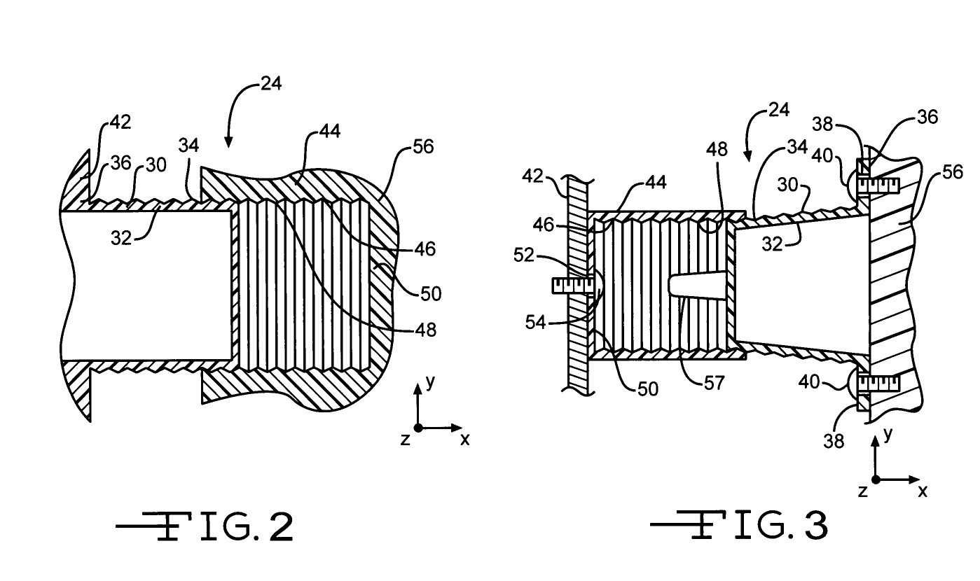

Referring now to FIG. 2, there is shown the energy absorption device 24 in accordance with a first embodiment of the present invention. The energy absorption device 24 includes a first body, e.g. first cup, 30, shown as having a cylindrical protrusion 32, and a second body, e.g. second cup, 44, shown as having a cylindrical cavity 46. The protrusion 32 is partially inserted into the cavity 46. The protrusion 32 has an outer serrated surface 34, which mates with a complementary inner serrated surface 48 of the cavity 46.

The energy absorption device 24 includes the first body 30 having the protrusion 32 defining the axially extending outer serrated surface 34. An annular mounting flange 36 extends from one end of the first body 30. The flange 36 is formed integrally to a main door trim panel 42 of the vehicle door 22.

As illustrated, the protrusion 32 is generally cylindrical in shape and defines the generally axially extending outer serrated surface 34. It must be understood, however, that the protrusion 32 may be rectangular, conical, or any other suitable shape, as will be further discussed below. The outer serrated surface 34 defines a series of teeth and grooves that circumscribe the protrusion 32. It must be understood, however, that the teeth and grooves need not fully circumscribe the protrusion 32. The teeth and grooves may be intermittently disposed about the outer serrated surface 34. It must be further understood that the protrusion 32 need not include the outer serrated surface 34; the protrusion 32 may include any suitably contoured surface, as will be further discussed below.

The energy absorption device 24 includes the second body 44 having the cavity 46 defining the generally axially extending inner serrated surface 48. A mounting disk 50 is formed integrally with a door armrest trim panel 56 of the vehicle door 22.

The illustrated cavity 46 is generally cylindrical in shape. It must be understood, however, that the cavity 46 may be rectangular, conical, or any other suitable shape, as will be further discussed below. The inner serrated surface 48 defines a series of teeth and grooves that inscribe the cavity 46. It must be understood, however, that the teeth and grooves need not fully inscribe the cavity 46. The teeth and grooves may be intermittently disposed about the inner serrated surface 48. It must be further understood that the cavity 46 need not include the inner serrated surface 48; the cavity 46 may include any suitably contoured surface, as will be further discussed below.

The protrusion 32 is partially inserted into the cavity 46, e.g. a nesting arrangement. The energy absorption device 24 thus supports the first body 30 and the second body 44 relative to one another in the “Y” and “Z” direction. However, upon an impact, at least partially in the “X” or axial direction, the protrusion 32 and the cavity 46 are moved relative to one another to absorb at least some of the impact energy. The energy absorption device 24 thereby stabilizes the main door trim panel 42 and the door armrest trim panel 56 relative to one another in two dimensions and manages impact energy in the third, together all forming an energy absorption vehicle interior assembly.

After an impact, the protrusion 32 and the cavity 46 will have been moved relative to one another in the axial direction. As the outer serrated surface 34 and the inner serrated surface 48 move across one another a certain amount of force is required for the teeth and grooves to pass one another and thus at least some of the impact energy is absorbed.

Although, in the embodiment shown in FIG. 2, the first body 30 is formed integrally to the door trim panel 42 and the second body 44 is formed integrally to the armrest trim panel 56, it must be understood, however, that either body 30, 44 may be associated with either trim panel 42, 56, i.e. either the first body 30 or the second body 44 may be oriented toward the interior or exterior of the vehicle. It must be further understood that the energy absorption device 24 may be placed between any suitable interior vehicle members, such as a trim panel and a frame member, or any other suitable interior vehicle member.

In another embodiment of the present invention shown in FIG. 3, the first body 30 is associated with the armrest trim panel 56 and the second body 44 is associated with the door trim panel 42.

In this embodiment, the annular mounting flange 36 extends from one end of the first body 30. The flange 36 includes at least one aperture 38 for receiving a fastener 40 to mount the first body 30 to the door armrest trim panel 56 of the vehicle door 22. The fastener 40 may be any suitable fastener such as a screw, bolt, barb or any other suitable fastener. Further, it must be understood that the first body 30 need not be attached to the door armrest trim panel 56 by the fastener 40 and that the first body 30 may be attached to the door armrest trim panel 56 by any suitable arrangement such as by adhesives, welding, or any other suitable arrangement. Additionally, the first body 30 may be attached to any suitable vehicle trim mounting member, such as the main door trim panel 42, any suitable trim panel, any suitable frame member, or any other suitable trim mounting member.

In this embodiment, the mounting disk 50 extends across one end of the second body 44. The disk 50 includes at least one aperture 52 for receiving a fastener 54 to mount the second body 44 to the main door trim panel 42 of the vehicle door 22. The fastener 54 may be any suitable fastener such as a screw, bolt, barb or any other suitable fastener. Further, it must be understood that the second body 44 need not be attached to the main door trim panel 42 by the fastener 54 and that the second body 44 may be attached to the door armrest trim panel 54 by any suitable arrangement such as by adhesives, welding, or any other suitable arrangement. Additionally, the second body 30 may be attached to any suitable vehicle trim member, such as the door armrest trim panel 56, any suitable trim panel, any suitable cover member, or any other suitable trim member.

In this embodiment, the protrusion 32 is conical. Specifically, the protrusion 32 is taped to form a truncated cone. It must be understood that the shape of the protrusion 32 and the cavity 46 may be configured to any suitable shape to absorb impact energy in a desired manner. Thus, in the present embodiment, the protrusion 32 moves relative into the cavity 46 a greater and greater amount of force is required for the protrusion 32 to further move into the cavity 46, and thereby absorbs greater and greater amounts of energy. Also, in this embodiment, the second body 44 includes a fissure 57 to direct deformation of the second body 44 upon impact. The fissure 57 is formed as a generally axial slot in the second body 44. It must be understood, however, that the fissure 57 may have any suitable form, such as an aperture, a slit, a depression, a void, or any other suitable form. Further, it must be understood that the fissure 57 may be in the first body 30, and that either the first body 30 or the second body 44 may have a plurality of fissures.

The particular profile or contour of the inner serrated surface 48 and/or the outer serrated surface 34 may be designed to create specific energy absorption characteristics. For example, as shown in FIG. 4, teeth 58, 60, 62 have similar geometry with a first side 64 and a second side 66. In this embodiment, the first side 64 is a long side and the second side 66 is a short side, thus, depending on the direction of motion, the inner serrated surface 48 and the outer serrated surface 34 will be engaging at a steeper of shallower angle, thereby increasing or decreasing the amount of force required for movement, and varying the amount of energy absorbed based upon desire.

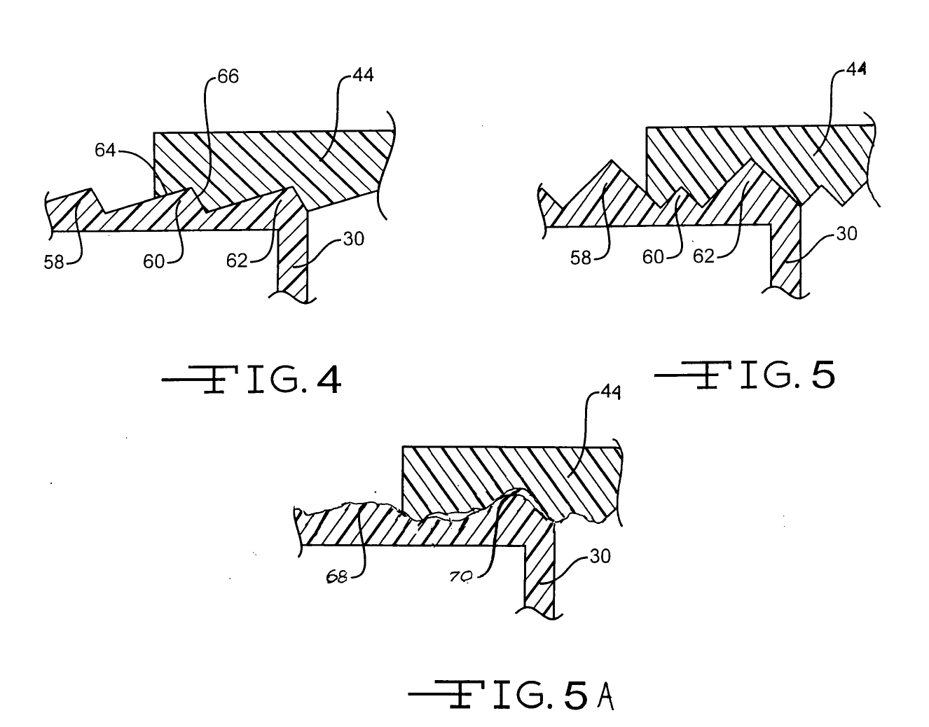

In another example, shown in FIG. 5, the teeth 58, 60, 62 vary in height. As shown the teeth 58, 60, 62 alternate between low and high height, i.e. low teeth and high teeth, and thus change the energy absorption characteristics.

In an additional example, shown in FIG. 5A, the protrusion 30 has a roughened irregular outer surface 68 and the cavity 70 has a roughened irregular inner surface 70.

It must be understood that the surfaces of the protrusion 30 and the cavity 70 may have any suitable contour and/or texture, such as serrated, roughened, toothed, corrugated, or any other suitable contour and/or texture.

It must be understood that the geometry of the teeth may be varied by changing the height of the teeth, length of the sides, or the angels at which they intersect.

As illustrated, energy absorption device 24 is formed from plastic. However, it must be understood that the energy absorption device 24 may be made from any suitable material, such as metal, or any other suitable material.

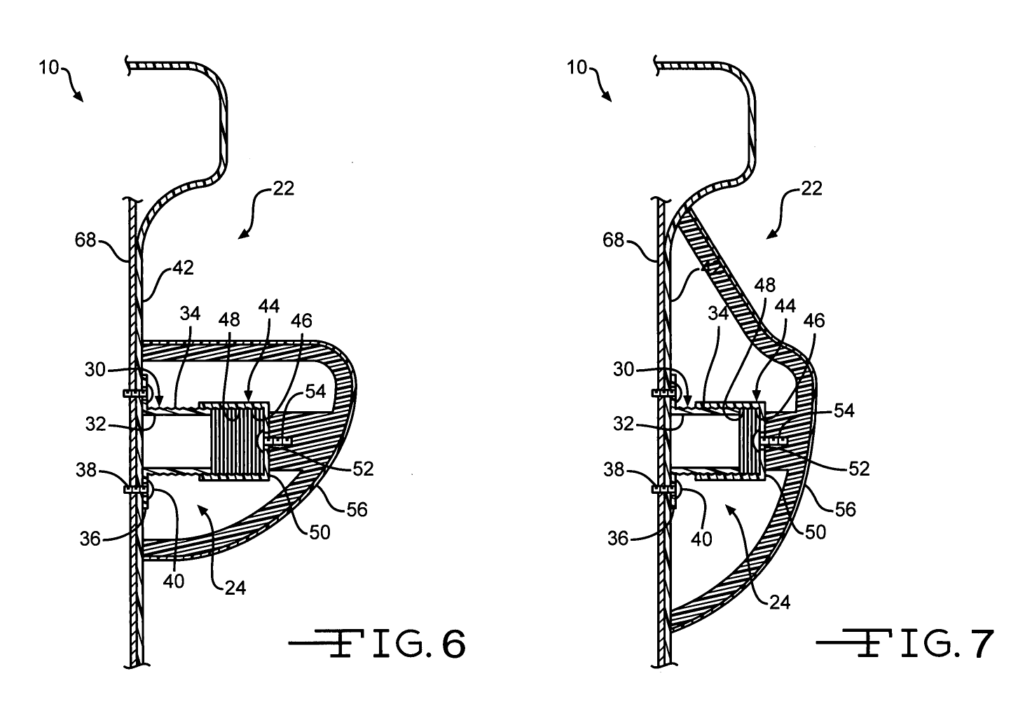

Referring now to FIG. 6, there is shown an enlarged portion of the vehicle interior passenger compartment 10 showing a cross-section of the vehicle door 22. The energy absorption device 24 is mounted between the main door trim panel 42 and the door armrest trim panel 56. The first body 30 is mounted to the main door trim panel 42 and a steel door frame member 68 via the annular mounting flange 36 and the fasteners 40. It must be understood that either the first body 30 or the second body 44 may be mounted to any suitable vehicle member, such as a trim member, frame member, or any other suitable member.

As shown in FIG. 6, the protrusion 32 is partially inserted into the cavity 46, e.g. a nesting arrangement. The energy absorption device 24 thus supports the first body 30 and the second body 44 relative to one another in the “Y” and “Z” direction. However, upon an impact, at least partially in the “X” or axial direction, the protrusion 32 and the cavity 46 are moved relative to one another to absorb at least some of the impact energy. The energy absorption device 24 thereby stabilizes the main door trim panel 42 and the door armrest trim panel 56 relative to one another in two dimensions and manages impact energy in the third, together all forming an energy absorption vehicle interior assembly.

As shown in FIG. 7, after an impact, the protrusion 32 and the cavity 46 have been moved relative to one another in the axial direction. As the outer serrated surface 34 and the inner serrated surface 48 move across one another, a certain amount of force is required for the teeth and grooves to pass one another and thus at least some of the impact energy is absorbed.

While the principle and mode of operation of this invention have been explained and illustrated with regard to particular embodiments, it must be understood, however, that this invention may be practiced otherwise than as specifically explained and illustrated without departing from its spirit or scope.

What is claimed is:

1. An energy absorption device for use in a vehicle interior comprising:
a first body having a protrusion defining an axially extending outer surface; and
a second body having a cavity defining a an axially extending inner surface engageable with said outer surface;
wherein said protrusion is at least partially inserted into said cavity to at least partially support said first body and said second body relative to one another,
wherein said outer surface and said inner surface each have a predetermined configuration which cooperates to provide resistance to axial movement of said protrusion into said cavity,
wherein upon an impact of an occupant of the vehicle with one of said first body and said second body, at least partially in the axial direction, said protrusion is axially moved further into said cavity to absorb at least some of the impact energy.

2. The energy absorption device according to claim 1 wherein one of said first body and said second body are formed integrally to a vehicle trim panel.

3. The energy absorption device according to claim 1 further comprising a vehicle trim panel, wherein one of said first body and said second body is attached to said vehicle trim panel.

4. The energy absorption device according to claim 3 further comprising a portion of a vehicle frame, wherein the other of said first body and said second body is attached to said portion of said vehicle frame.

5. The energy absorption device according to claim 1 wherein at least one of said cavity and said protrusion is conical.

6. The energy absorption device according to claim 1 wherein one of said inner serrated surface and said outer serrated surface includes high teeth and low teeth.

7. The energy absorption device according to claim 1 wherein said first body and said second body are formed from plastic.

8. The energy absorption device according to claim 1 wherein at least one of said first body and said second body include at least one fissure to direct deformation of said respective body upon impact.

9. The energy absorption device according to claim 1 wherein at least one of said first body and said second body include at least one void to direct deformation of said respective body upon impact.

10. The energy absorption device according to claim 1 wherein at least one of said outer surface and said inner is a serrated surface.

11. The energy absorption device according to claim 1 wherein least one of said outer surface and said inner surface is a roughened surface.

12. The energy absorption device according to claim 11 wherein said roughened surface is an irregular roughened surface.

13. The energy absorption device according to claim 1 wherein said predetermined configuration provides for increasing resistance to axial movement of said protrusion into said cavity.
